(19) United States
(12) Patent Application Publication
(10) Pub. No.: US 2004/0223297 A1
(43) Pub. Date: Nov. 11, 2004

(54) Television set having positioning structure for mounting cathode ray tube

(76) Inventors: Masakuni Kobashi, Fukui (JP); Koichi Tajima, Fukui (JP)

Correspondence Address: WENDEROTH, LIND & PONACK, L.L.P., 2033 K STREET N. W., SUITE 800, WASHINGTON, DC, 20006-1021, US

(21) Appl. No.: 10/830,319

(22) Filed: Apr. 23, 2004

(30) Foreign Application Priority Data
Apr. 25, 2003 (JP) 2003-121629

(51) Int. Cl. G06F 1/16

(52) U.S. Cl. 361/682

(57) ABSTRACT

To provide a television set having a positioning structure for mounting a cathode ray tube very simple to correctly position and mount a cathode ray tube on bosses and can cushion impact acting on the bosses and prevent the impact from being transmitted to a cabinet body, it includes reinforcement ribs formed with positioning ribs extending toward an opening window, into which a picture display of a cathode ray tube is fitted, and tip ends of the positioning ribs are close to or in contact with an outer peripheral surface of the cathode ray tube.

### BACKGROUND OF THE INVENTION

1. Field of the Invention

The present invention relates to a television set having a positioning structure for mounting a cathode ray tube in which a cathode ray tube is fixed in a predetermined position in a cabinet.

2. Related Art

A very heavy cathode ray tube (CRT) is mounted on a cabinet of a television set. A conventional cabinet is a frame made of a resin to be substantially quadrilateral in shape, and has an opening window, to which the cathode ray tube is mounted and in which a picture display is arranged. And, brackets extended from corners of the cathode ray tube are screwed to bosses provided on a cabinet front surface that is formed around the opening window.

The brackets of the cathode ray tube are screwed to threaded holes formed on the bosses. It is essential that the cathode ray tube be correctly fitted onto the opening window formed on the cabinet front surface to be positioned. And, since a structure, in which only the bosses stand upright from the front surface, is weak in strength, reinforcement ribs are formed between the bosses and inner wall surfaces of the cabinet. When deflection and deformation of the bosses are caused by a weight load of the cathode ray tube, however, the weight load is transmitted to the cabinet walls through the reinforcement ribs and the walls are deformed to change in color to become white.

Hereupon, “Braun tube mount structure” according to JP-A-07-264514 is known as a conventional art that solves the problem. With the Braun tube mount structure, blow molding is used to achieve an increase in thickness to increase strength and guide ribs are provided to have tapered surfaces thereof guiding sides of a Braun tube, thereby guiding the Braun tube to a mount position. Thus, as the Braun tube is being inserted, the Braun tube can be accurately guided to the mount position and strength, with which the Braun tube is held, is enhanced since the ribs are large in thickness. Since the ribs that guide the Braun tube extend from inside the cabinet inner wall surfaces, however, an excessively large impact during shipment is transmitted directly to the cabinet, so that there is a fear that the cabinet walls are deformed and outer wall surfaces thereof are subjected to whitening or breakage.

“Front cabinet for CRT” according to JP-A-08-336089 comprises plate-shaped guide ribs provided on inner wall surfaces of a cabinet to project toward sides of a CRT, the guide ribs being stepwise-shaped to be thick in a base-side (sides toward the cabinet inner wall surfaces) region and thin in a tip-end side region. Also, the guide ribs are set in height such that the CRT is surely brought into contact with the guide ribs irrespective of dimensional tolerance thereof. When the CRT is caused to bear against a picture opening of the cabinet, the CRT is brought into contact with and guided by tip ends of the guide ribs, so that it is possible to achieve correct positioning.

Since the tip ends of the guide ribs are formed to be thin, however, it is not possible to suppress a swinging motion of the CRT due to an impact and there is a fear of causing misregistration. Conversely, when the tip ends of the guide ribs are made large in thickness, they will become fragile. Further, the guide ribs gets in the way at the time of mounting of the CRT to lower productivity since the tip ends of the guide ribs are provided in positions to be in contact with the CRT at all times and the guide ribs are extended vertically relative to a direction, in which the CRT is mounted.

“Braun tube supporting structure” according to JP-U-3057180 comprises cylindrical bodies provided around bosses for fixation of a Braun tube to be able to absorb an impact, and reinforcement ribs, and the cylindrical bodies that contact with the Braun tube to absorb an impact and the reinforcement ribs constitute bearing bosses that are formed integrally from a rear surface of a cabinet. However, the cylindrical bodies being brought into contact with the Braun tube cannot be returned to their original states once they are much deformed by an impact, so that they are low in reliability as cushioning structures. Further, since a plurality of the cylindrical bodies for cushioning are provided separately from the bosses for fixation of a Braun tube, a mold around the boss is divided into a plurality of blocks to be complicated in shape and the mold is decreased in strength and reduced in life of molding. In keeping with reduction in life of molding, mass production of cabinets is restricted and the production cost is correspondingly increased.

In this manner, the problems described above are involved in a television set having a positioning structure for mounting a cathode ray tube (CRT).

### SUMMARY OF THE INVENTION

The invention aims at solving the problems and provides a television set having a positioning structure for mounting a cathode ray tube, which is not complicate in shape but very simple to correctly position and mount a cathode ray tube on bosses, and which cushions impact acting on the bosses and prevents the impact from being transmitted to a cabinet body.

The invention provides a television set having a positioning structure for mounting a cathode ray tube, which comprises positioning ribs provided for correct mounting of a very heavy cathode ray tube and provides for reinforcing bosses formed at corners of a cabinet and an entire cabinet, and which prevents an impact from being transmitted to wall bodies that constitute a cabinet body. Thus, the bosses are provided at respective corners of a cabinet to stand upright from a cabinet front surface, and ribs are provided for reinforcing the bosses and the front surface. Formed on the bosses are threaded holes, to which brackets extending outward from corners of a cathode ray tube are screwed.

Reinforcement ribs are different in configuration. The reinforcement ribs are provided at predetermined distances from cabinet inner walls and can be connected to the cabinet inner walls through connection ribs. Positioning ribs are extended inward (toward an opening window) from the reinforcement ribs and positioned to abut against or approach an outer peripheral surface of a cathode ray tube. Here, the positioning ribs are provided in positions away from the connection ribs so that an impact from the cathode ray tube is not transmitted to the connection ribs via the positioning ribs to have an influence on the cabinet wall body. Embodiments of the invention will be described below in detail with reference to the drawings.

### BRIEF DESCRIPTION OF THE DRAWING

FIG. 1 is a perspective view showing a cabinet with a cathode ray tube mounted thereto;

FIG. 2 is a rear view showing a television set having a positioning structure for mounting a cathode ray tube, according to the invention;

FIG. 3 is a view showing a state, in which a cathode ray tube is mounted to the cabinet;

FIG. 4 is a view showing a television set having a positioning structure for mounting a cathode ray tube, according to the invention;

FIG. 5 is a perspective view showing partial details of the mount structure of FIG. 4; and

FIG. 6 is a view showing a television set having a positioning structure for mounting a cathode ray tube, according to the invention.

### DETAILED DESCRIPTION OF PREFERRED EMBODIMENT

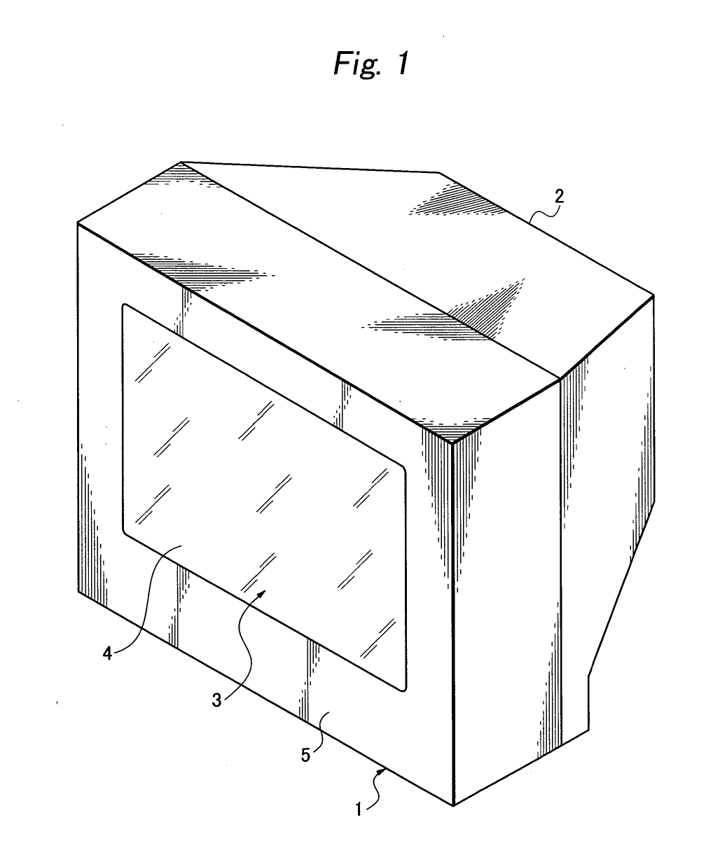

FIG. 1 shows an external appearance of a television set, and in the figure, the reference numeral 1 denotes a cabinet, 2 a back lid, and 3 a cathode ray tube (CRT). The cabinet 1 defines a quadrilateral frame, the cathode ray tube 3 is mounted in the cabinet 1, and a picture display 4 of the cathode ray tube 3 is fitted into an opening window on a cabinet front surface 5.

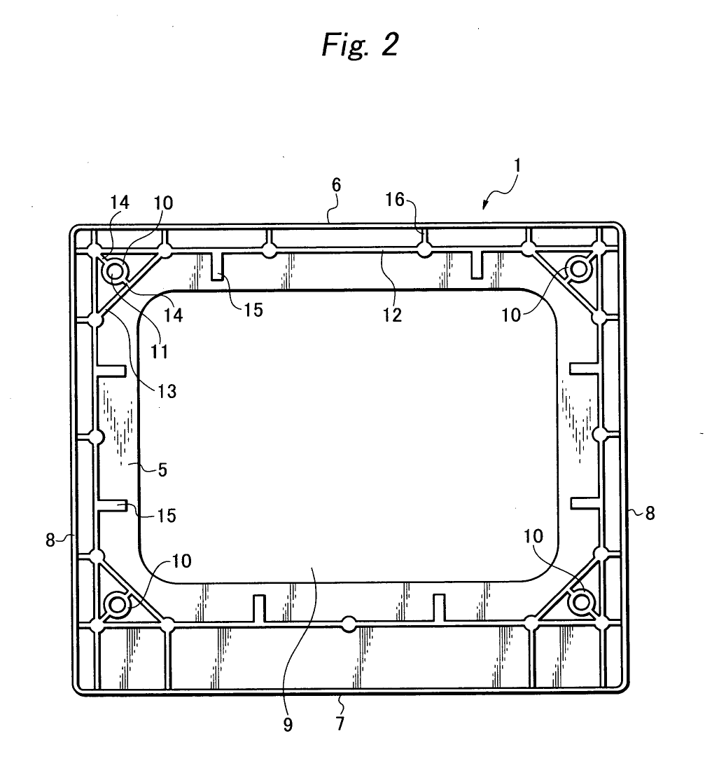

FIG. 2 is a rear view showing the cabinet 1. The cabinet 1 is a molding made of a resin in the form of a rectangular frame, and comprises an upper surface 6, a lower surface 7, and both side surfaces 8, 8, the cabinet being fully opened at a rear side thereof and formed at the front surface 5 thereof with an opening window 9, into which the picture display of the cathode ray tube is fitted. And, bosses 10, 10, . . . are provided on respective corners of the cabinet 1, which comprises a rectangular frame, to stand vertically upright from the front surface 5, and threaded holes 11 are formed on the bosses 10.

While brackets extended from corners of the cathode ray tube are screwed onto the bosses 10, various ribs shown in the figure are provided since the heavy cathode ray tube cannot be supported only by the four bosses 10, 10, . . . that stand upright from the front surface 5. In the embodiment shown in the figure, reinforcement ribs 12, 12, . . . are provided in parallel to and at predetermined spaces from the upper surface 6, the lower surface 7, and the both side surfaces 8, 8, and the reinforcement ribs 12, 12, . . . are connected through connection ribs 16, 16, . . . to the upper surface 6, the lower surface 7, and the both side surfaces 8, 8.

Auxiliary ribs 13, 13, . . . are provided at comers, at which the reinforcement ribs 12, 12, . . . intersect one another, to cross adjacent reinforcement ribs 12, 12, . . . to form triangular structures. The bosses 10, 10, . . . are provided inside the triangular structures and connection ribs 14, 14 extended from the bosses 10 are connected to the triangular structures. The triangular structure with the boss 10 arranged centrally is provided at the respective corners of the cabinet 1 shown in the figure, and the triangular structures are connected together by the reinforcement ribs 12, 12, . . . .

And, positioning ribs 15, 15, . . . are extended toward the opening window from the reinforcement ribs 12, 12, . . . and positioned intermediate between positions of the connection ribs 16, 16, . . . , so that the cabinet 1 is enhanced in strength/rigidity by the respective ribs, 12, 12, . . . , 13, 13, . . . , 16, 16, . . . . The positioning ribs 15, 15, . . . are provided two to an upper surface side, a lower surface side, and both vertical surface sides, respectively, to afford positioning the cathode ray tube, a picture display of which is fitted into and mounted to the opening window 9, and to serve as cushioning means when an impact acts on the cathode ray tube.

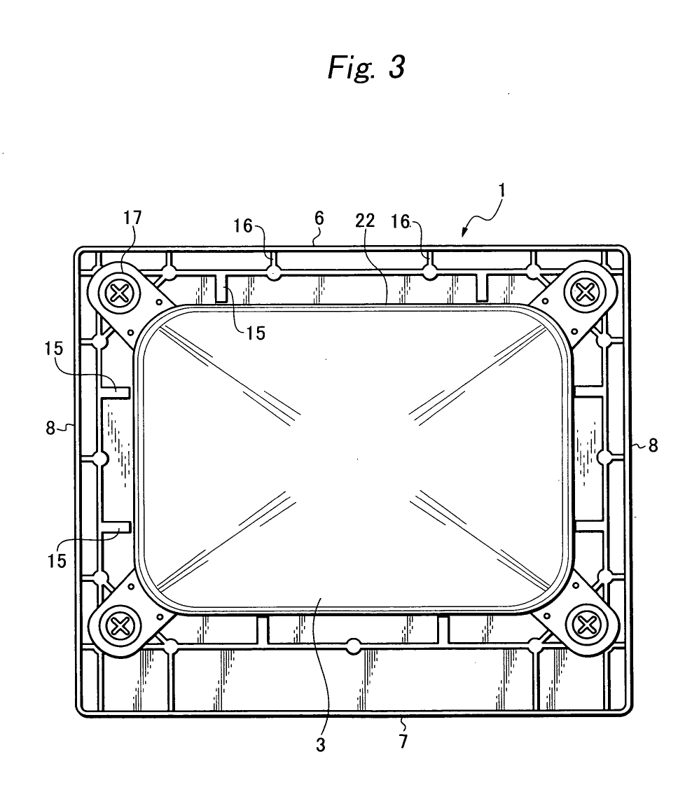

FIG. 3 shows a state, in which the cathode ray tube 3 is mounted on the cabinet 1 with the picture display fitted into the opening window 9. Brackets 17, 17, . . . are mounted on respective corners of the cathode ray tube 3, the brackets 17, 17, . . . being fixed to the bosses 10, 10, . . . by means of screws. In this case, tip ends of the positioning ribs are close to or in contact with an outer peripheral surface 22 of the cathode ray tube 3 to be able to mount the cathode ray tube 3 correctly in a predetermined position. Here, the tip ends of the positioning ribs 15, 15, . . . may be tapered to enable facilitating mounting of the cathode ray tube 3.

The cathode ray tube 3 is mounted on the cabinet 1 through the brackets 17, 17, . . . but not supported by the positioning ribs 15, 15, . . . . In the case where some impact acts on the cathode ray tube 3, the bosses 10, 10, . . . , to which the brackets 17, 17, . . . are screwed and fixed, are deformed and the surrounding ribs for reinforcing the bosses 10, 10, . . . are also deformed. In this case, the cathode ray tube 3 also strikes against the tip ends of the positioning ribs to push against the positioning ribs 15, 15, . . . .

When a pushing force acts on the positioning ribs 15, 15, . . . , the reinforcement ribs 12 extending in parallel to inner wall surfaces of the cabinet are bent and deformed. The connection ribs 16, 16 connected to the inner wall surfaces of the cabinet constitutes a double end supporting configuration of the reinforcement rib 12, so that the reinforcement rib 12 is bent and deformed between the both connection ribs, thus enabling restricting an influence on the cabinet wall as far as possible. Therefore, it is preferable that the positioning rib 15 be provided in a position intermediate between the both connection ribs 16, 16. In this manner, by providing the positioning ribs 15, 15, . . . on the cabinet 1, it is possible to reduce a load on the bosses 10, to which the brackets 17 are screwed, and the ribs around the bosses and to prevent whitening generated on outer wall surfaces of the cabinet and breakage thereof.

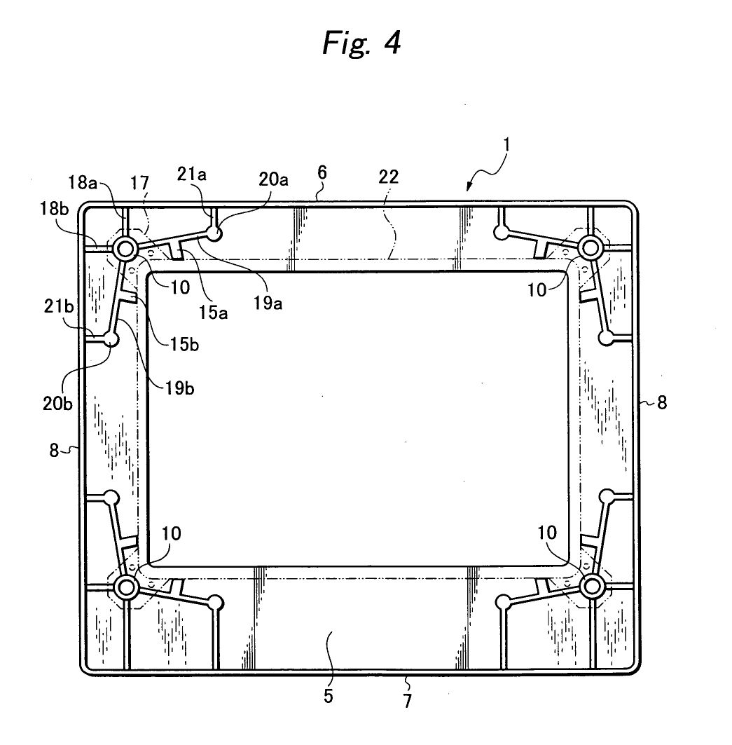

FIG. 4 shows a further embodiment of a cabinet according to the invention. As shown in the figure, bosses 10 are provided at respective comers of a cabinet 1 to stand upright from a front surface 5, and the brackets 17 mounted at comers of the cathode ray tube 3 are screwed to the bosses 10. The cathode ray tube 3 is indicated by dotted lines in the figure. First reinforcement ribs 18a, 18b and second reinforcement ribs 19a, 19b are extended on both sides of the boss 10, the first reinforcement ribs 18a, 18b being connected to inner wall surfaces of the cabinet, the second reinforcement ribs 19a, 19b being provided at tip ends thereof with struts 20a, 20b, and connection ribs 21a, 21b extended from the struts 20a, 20b are connected to the inner wall surfaces of the cabinet.

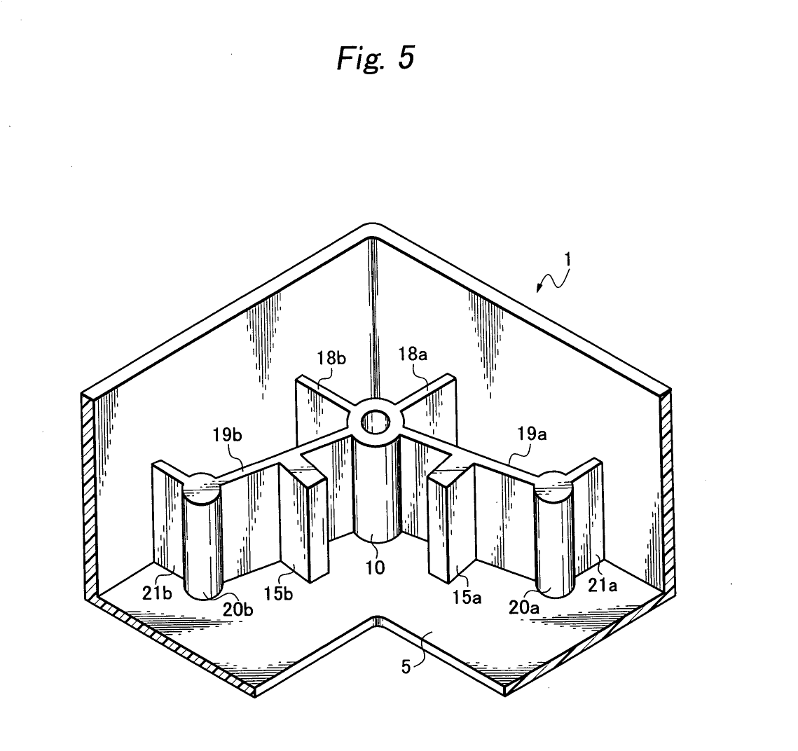

FIG. 5 three-dimensionally shows the boss 10, the first reinforcement ribs 18a, 18b, and the second reinforcement ribs 19a, 19b. The boss 10 is reinforced at its surrounding by the first reinforcement ribs 18a, 18b and the second reinforcement ribs 19a, 19b, and the second reinforcement ribs 19a, 19b are provided at intermediate portions thereof with positioning ribs 15a, 15b, tip ends of which are close to or in contact with the outer peripheral surface 22 of the cathode ray tube 3. Hereupon, the cathode ray tube 3 mounted on the cabinet 1 is positioned in a predetermined position by the positioning ribs 15a, 15b, which can absorb an impact applied on the cathode ray tube 3 at the same time to restrict an influence on the walls of the cabinet.

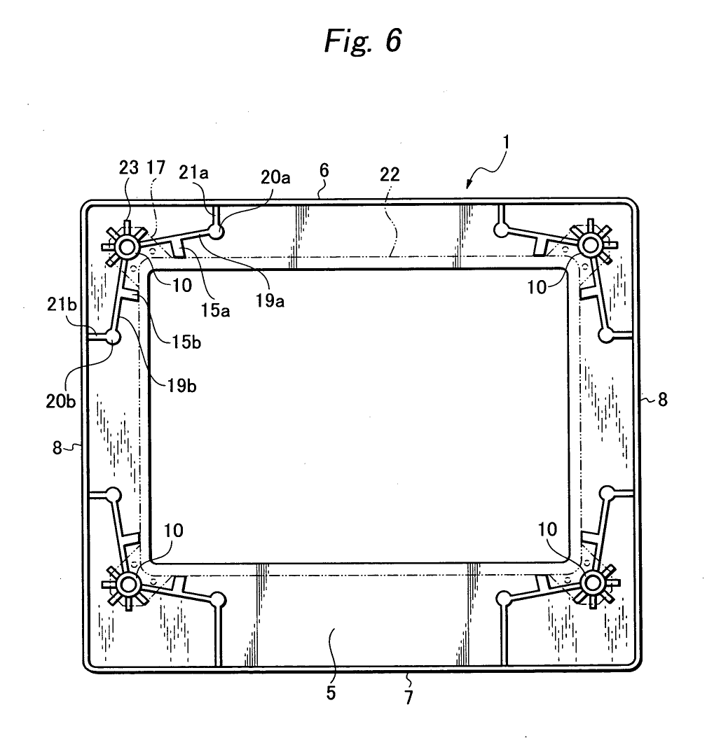

FIG. 6 shows a still further embodiment of a mount structure according to the invention. A fundamental configuration of the embodiment is the same as that of the embodiment shown in FIG. 4. First small reinforcement ribs 23, 23, . . . are provided around a boss 10 and second reinforcement ribs 19a, 19b are extended on both sides. The second reinforcement ribs 19a, 19b are provided at tip ends thereof with struts 20a, 20b, and connection ribs 21a, 21b extended from the struts 20a, 20b are connected to the inner wall surfaces of the cabinet.

The second reinforcement ribs 19a, 19b are provided at intermediate portions thereof with positioning ribs 15a, 15b, tip ends of which are close to or in contact with the outer peripheral surface 22 of the cathode ray tube 3. Hereupon, the cathode ray tube 3 mounted on the cabinet 1 is positioned in a predetermined position by the positioning ribs 15a, 15b, which can absorb an impact applied on the cathode ray tube 3 at the same time to restrict an influence on the walls of the cabinet.

As described above, the television set having a positioning structure for mounting a cathode ray tube, according to the invention, comprises bosses provided at the corners of the cabinet, reinforcement ribs formed to extend from around the bosses, and positioning ribs extended inward from the reinforcement ribs, and can produce the following effects.

The television set having a positioning structure for mounting a cathode ray tube according to the invention comprises bosses provided upright on corners of a cabinet and ribs provided around the bosses. And, positioning ribs are extended from the ribs, and tip ends of the positioning ribs are close to or in contact with an outer peripheral surface of a cathode ray tube, a picture display of which is fitted into and mounted to an opening window of the cabinet, whereby the cathode ray tube can be correctly positioned and mounted.

Also, the positioning ribs not only position a cathode ray tube but also can bear a part of an impact load by the positioning ribs because when an impact acts on a heavy cathode ray tube, the bosses, to which brackets are fixed, are deformed and an outer peripheral surface of the cathode ray tube strikes against the positioning ribs. While the positioning ribs are also deformed to be able to absorb an impulsive force, influence of an impact on the walls of the cabinet can be restricted by separating positions of the positioning ribs from the ribs connected to the inner wall surfaces of the cabinet, deformation of the walls of the cabinet can be restricted, and phenomena such as whitening generated on the outer wall surfaces and breakage can be prevented.

The invention provides a simple structure comprising bosses, to which a cathode ray tube is mounted, ribs for reinforcing the bosses, and positioning ribs extended from the ribs, and the structure can be molded integrally together with a cabinet body at the same time. Accordingly, a molding die is made simple, the manufacturing cost is inexpensive, and the molding die is extended in life.

What is claimed is:

1. A television set having a positioning structure for mounting a cathode ray tube, comprising bosses for mounting of a cathode ray tube, the bosses being provided at respective corners of a cabinet to stand upright from a front surface of the cabinet, and reinforcement ribs for reinforcing the bosses and the front surface, and wherein the reinforcement ribs are formed with positioning ribs extending toward an opening window, into which a picture display of the cathode ray tube is fitted, and tip ends of the positioning ribs are close to or in contact with an outer peripheral surface of the cathode ray tube.

2. A television set having a positioning structure for mounting a cathode ray tube, according to claim 1, further comprising connection ribs provided for connecting the reinforcement ribs and inner wall surfaces of the cabinet, and wherein the positioning ribs are provided in positions away from the connection ribs.

3. A television set having a positioning structure for mounting a cathode ray tube, comprising bosses for mounting of a cathode ray tube, the bosses being provided at respective corners of a cabinet to stand upright from a front surface of the cabinet, reinforcement ribs for reinforcing the bosses and the front surface, the reinforcement ribs being arranged at predetermined spaces from and along inner wall surfaces of the cabinet, connection ribs provided at places on the reinforcement ribs and connected to the inner wall surfaces, and positioning ribs formed intermediate between adjacent connection ribs and extending toward an opening window, into which a picture display of the cathode ray tube is fitted, from the reinforcement ribs, and wherein tip ends of the positioning ribs are close to or in contact with an outer peripheral surface of the cathode ray tube.
